(19) United States
(12) Patent Application Publication
(10) Pub. No.: US 2020/0159994 A1
(43) Pub. Date: May 21, 2020

(54) SYSTEM AND METHOD FOR SEGMENTING A TEXT

(71) Applicant: BEIJING DIDI INFINITY TECHNOLOGY AND DEVELOPMENT CO., LTD., Beijing (CN)

(72) Inventors: Jie BAI, Beijing (CN); Xiulin LI, Beijing (CN)

(73) Assignee: BEIJING DIDI INFINITY TECHNOLOGY AND DEVELOPMENT CO., LTD., Beijing (CN)

(21) Appl. No.: 16/749,959

(22) Filed: Jan. 22, 2020

Related U.S. Application Data
(63) Continuation of application No. PCT/CN2017/095335, filed on Jul. 31, 2017.

(51) Int. Cl. G06F 40/289

(52) U.S. Cl. CPC G06F 40/289

(57) ABSTRACT

Embodiments of the disclosure provide systems and methods for segmenting a text. The method may include identifying, by a processor, a candidate phrase shared by a plurality of sample texts; determining, by the processor, an evaluation score for the candidate phrase; identifying, by the processor, the candidate phrase as an organization phrase when the evaluation score meets a predetermined criterion; and segmenting the text based on the organization phrase.

### CROSS REFERENCE TO THE RELATED APPLICATIONS

The present application is a continuation of International Application No. PCT/CN2017/095335 filed on Jul. 31, 2017, designating the United States of America. The entire contents of the above-referenced application are incorporated herein by reference.

### TECHNICAL FIELD

The present disclosure relates to text processing techniques, more particularly to extracting an organization phrase from sample texts and segmenting a text based on the organization phrase.

### BACKGROUND

Text-to-Speech techniques can transcribe a text sentence into audio signals. For example, in a navigation application (e.g., a DiDi app), the text sentence, such as traffic condition, addresses, or the like may be presented to a user by voice.

To be read in a natural way, a piece of text (e.g., a sentence) must be segmented properly before being transcribed into audio signals. Generally, each of the phrases that are included in a sentence contains one or more words. Consistent with this disclosure, a word can be in English, French, Spanish, etc. a word in Latin, or a character of Asian languages such as Chinese, Korean, Japanese, etc. These words or characters may be segmented into phrases in a plurality of possible combinations.

A text sentence may contain address information or a Point of Interest (POI), which may be referred to as an “organization phrase.” For example, in a text sentence “China-Singapore Industrial Park is 30 kilometers away” for navigation, “Industrial Park” is an organization phrase. Based on the organization phrase, the above sentence may be segmented as “China-Singapore/Industrial Park/is/30 kilometers away.” Thus, the organization phrase may be used to facilitate a proper segmentation of the text sentence.

Embodiments of the disclosure provide improved systems and methods for extracting an organization phrase and segmenting a text based on the organization phrase.

### SUMMARY

An aspect of the disclosure provides a method for segmenting a text. The method may include identifying, by a processor, a candidate phrase shared by a plurality of sample texts; determining, by the processor, an evaluation score for the candidate phrase; identifying, by the processor, the candidate phrase as an organization phrase when the evaluation score meets a predetermined criterion; and segmenting the text based on the organization phrase.

Another aspect of the disclosure provides a system for segmenting a text. The system may include a communication interface configured for receiving a plurality of sample texts; a memory; and a processor configured for identifying a candidate phrase shared by the plurality of sample texts; determining an evaluation score for the candidate phrase; identifying the candidate phrase as an organization phrase when the evaluation score meets a predetermined criterion; and segmenting the text based on the organization phrase.

Yet another aspect of the disclosure provides a non-transitory computer-readable medium that stores a set of instructions, when executed by at least one processor of an electronic device, cause the electronic device to perform a method for generating a list of organization word entries. The method may include identifying a candidate phrase shared by the plurality of sample texts; determining an evaluation score for the candidate phrase; identifying the candidate phrase as an organization phrase when the evaluation score meets a predetermined criterion; and segmenting the text based on the organization phrase.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram of an exemplary system for segmenting a text, according to some embodiments of the disclosure.

FIG. 2 is a flowchart of an exemplary method for segmenting a text, according to some embodiments of the disclosure.

FIG. 3 is a flowchart of a process for determining an evaluation score, according to some embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

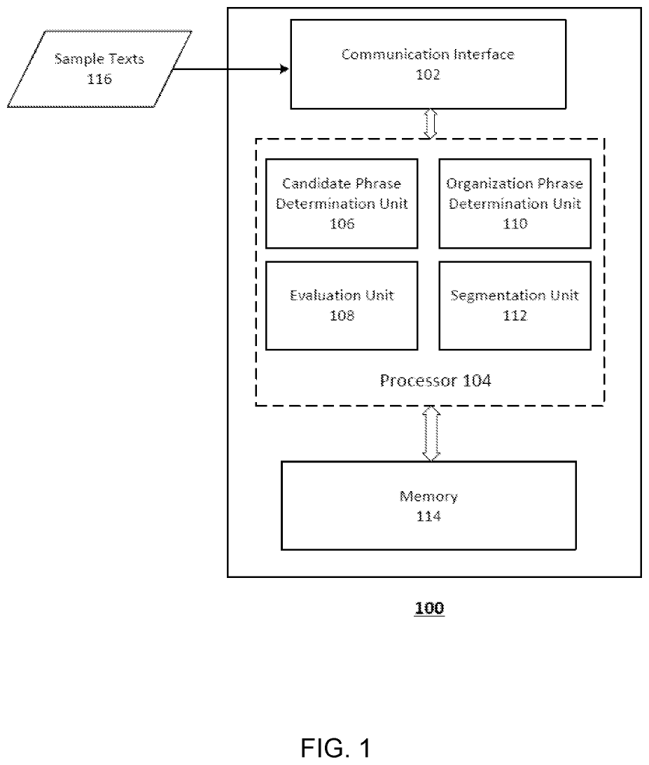

An aspect of the disclosure is directed to a system for segmenting a text. For example, FIG. 1 is a block diagram of an exemplary system 100 for segmenting a text, according to some embodiments of the disclosure.

System 100 may be a general server or a proprietary device for processing text information in a sentence. As shown in FIG. 1, system 100 may include a communication interface 102, a processor 104, and a memory 114. Processor 104 may further include multiple functional modules, such as a candidate phrase determination unit 106, an evaluation unit 108, an organization phrase determination unit 110, and a segmentation unit 112. These modules (and any corresponding sub-modules or sub-units) can be functional hardware units (e.g., portions of an integrated circuit) of processor 104 designed for use with other components or a part of a program. The program may be stored on a computer-readable medium, and when executed by processor 104, it may perform one or more functions. Although FIG. 1 shows units 106-112 all within one processor 104, it is contemplated that these units may be distributed among multiple processors located near or remotely with each other. System 100 may be implemented in the cloud, or on a separate computer/server.

Communication interface 102 may be configured to receive one or more sample texts 116. In some embodiments, sample texts 116 may address information to identify a location, such as a road, a building, a park, or the like.

Memory 114 may be configured to store one or more sample texts 116. Memory 114 may be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

Consistent with embodiments of the disclosure, candidate phrase determination unit 106 may determine a candidate phrase based on received sample texts 116. For example, a plurality of sample texts may include “Beijing Industrial Park”, “Shanghai Industrial Park”, “Silicon Valley Industrial Park”, “China-Singapore Industrial Park”, and “Beijing New Industrial Park”. Candidate phrase determination unit 106 may compare the plurality of sample texts, and determine that a shared phrase (e.g., “Industrial Park”) among sample texts 116 as the candidate phrase. In the above sample texts, the candidate phrase is at the end of each sample text.

Evaluation unit 108 may then determine an evaluation score for the candidate phrase. The evaluation score indicates a probability of the candidate phrase being an organization phrase. In some embodiments, the evaluation score may be determined based on whether the candidate phrase is associated with a proper segmentation path. That is, when a segmentation path that treats the candidate phrase as an organization phrase yields a higher evaluation score, it is an indication that the candidate phrase is indeed an organization phrase.

In a non-limiting example, evaluation unit 108 may generate a second segmentation path that is different from a first segmentation path including a segment corresponding to the candidate phrase, and determine whether the second segmentation path is a proper segmentation path. If the second segmentation path is less likely to be a proper segmentation path, the first segmentation, on the contrary, is more likely to be a proper segmentation path. And thus, candidate phrase is more likely to be an organization phrase.

Consistent with the disclosure, evaluation unit 108 may identify a reference phrase associated with the candidate phrase for each sample text, and determine a first number of sample texts that contain the reference phrase. The reference phrase may be associated with an improper segmentation of the sample text. For example, in a sample text “Camden High Street”, “High Street” may be determined as a candidate phrase, and evaluation unit 108 needs to determine whether the segmentation, based on the candidate phrase, is reasonable. To do that, evaluation unit 108 may generate an alternative segmentation, such as “Camden High/Street.” Based on this alternative segmentation, evaluation unit 108 may determine “Camden High” as a reference phrase, and determine a total number T of sample texts that contain “Camden High.” Then, evaluation unit 108 may segment each sample text into segments, and determine a second number of sample texts that contain a segment corresponding to the reference phrase. With reference to the above example, evaluation unit 108 may segment each sample text into segments using a language model, and determine a number M of sample texts that contain a segment associated with “Camden High.” The language model can generate a segmentation path according to natural language rules. That is, in the number M of sample texts, “Camden High” is segmented as a segment. As discussed above, the segmentation including “Camden High” as a segment is an improper segmentation. Thus, based on the numbers T and M, a segmentation failure rate p may be determined based on the numbers T and M. p may be calculated according to the equation below.

p=M×M/T

According to the above discussion, a reference phrase (e.g., “Camden High”) indicates an improper segmentation, therefore p indicates the segmentation associated with the reference phrase is improper. When the number M of sample texts that contain a segment associated with the reference phrase is small, the value of p is small, which indicates that the segmentation including the candidate phrase is more likely to be a proper segmentation as only a very few of other segmentations exist. For example, the sample text “Camden/High Street” may have a segmentation failure rate p of 0.4, the sample text “Shanxi/South Road” may have a segmentation failure rate p of 0.3, while “Luo/Nan Road” may have a segmentation failure rate p of 17.2.

It is contemplated that, the above language model may segment a text according to natural language rules. And the language model can be trained for a designated language, such as English, Chinese, Japanese, or the like.

Based on the segmentation failure rates calculated for each sample text, evaluation unit 108 may determine the evaluation score by averaging the segmentation failure rates of the respective sample texts. The respective sample texts may each include a segment associated with the candidate phrase. For example, “High Street” may have an evaluation score S of 0.988, and “Zhuang Street” may have an evaluation score S of 5.731. The individual scores may be aggregated in any suitable ways to derive the evaluation score. For example, instead of a straight average of the individual scores, the evaluation score may be a weighted average of the individual scores, and the weights may correspond to how frequently the associated sample text is used. For example, in a navigation app (e.g., the DiDi app), “China-Singapore Industrial Park” is more frequently used, the evaluation score for the candidate phrase “Industrial Park” generated based on this text will be assigned with a greater weight.

Organization phrase determination unit 110 may identify the candidate phrase as an organization phrase when the evaluation score meets a predetermined criterion. In some embodiments, the candidate phrase may be identified as an organization phrase when the evaluation score is less than a threshold. For example, the threshold may be predetermined as “1”. With reference to the above examples of “High Street” and “Zhuang Street”, “High Street” having the evaluation score S of 0.988 may be identified as an organization phrase.

Organization phrase determination unit 110 may further generate a list of organization phrases, and rank the list of organization phrases in an ascendant order of the respective evaluation scores. The list may be stored in memory 114 and used in further processing. In some embodiments, the list may be automatically or manually reviewed to remove one or more phrases that are known to be non-organization phrases.

Segmentation unit 112 may further segment a text based on the organization phrase. For example, when more than one segmentation paths are generated for one text using the language model, segmentation unit 112 may select a segmentation path including an organization phrase as a segment, and segment the text accordingly. Alternatively, the language model may be trained to automatically treat an organization phrase as a segment.

System 100 can extract organization phrases from sample texts, the extracted organization phrases may be further used to segment a text before the text being transcribed into audio signals.

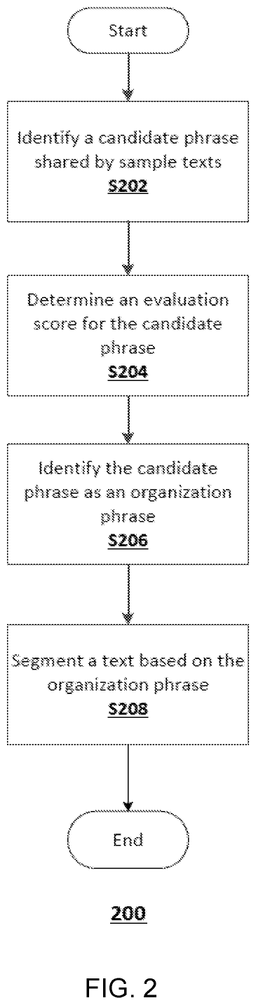

Another aspect of the disclosure is directed to a method for segmenting a text. For example, FIG. 2 is a flowchart of an exemplary method 200 for segmenting a text, according to some embodiments of the disclosure. In some embodiments, method 200 may be implemented by a segmentation device, and may include steps S202-S208.

In step S202, the segmentation device may identify a candidate phrase shared by a plurality of sample texts. The plurality of sample texts may be compared to determine the candidate phrase. In some embodiments, the candidate phrase is at the end of each sample text.

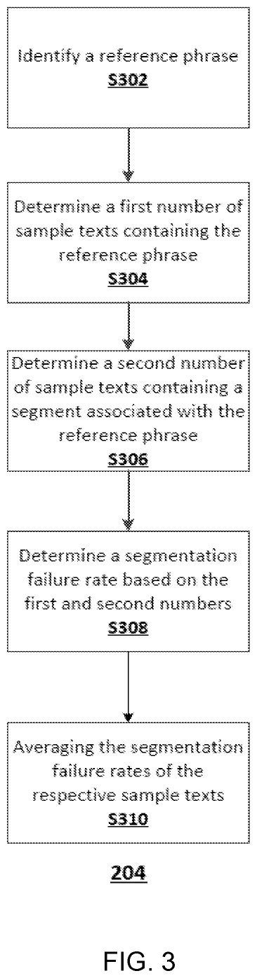

In step S204, the segmentation device may determine an evaluation score for the candidate phrase. The evaluation score may be determined based on multiple alternative segmentation paths of the text. At least one of the segmentation path includes the candidate phrase as a segment. FIG. 3 is a flowchart of a process 300 for determining an evaluation score, according to some embodiments of the disclosure.

As shown in FIG. 3, in step S302, the segmentation device may identify a reference phrase associated with the candidate phrase for each sample text. The reference phrase may be determined based on a segmentation path that is different from the segmentation path including the candidate phrase. In step S304, the segmentation device may determine a first number of sample texts that contain the reference phrase.

Then, in step S306, the segmentation device may segment each sample text into segments and determine a second number of sample texts that contain the reference phrase as a segment. In some embodiments, the sample text may be segmented using a language model. In step S308, the segmentation device may determine a segmentation failure rate based on the first and second numbers.

In step S310, the segmentation device may determine the evaluation score by aggregating (such as averaging) the segmentation failure rates of the respective sample texts. The respective sample texts may each include a segment associated with the candidate phrase.

With reference back to FIG. 2, in step S206, the segmentation device may identify the candidate phrase as an organization phrase when the evaluation score meets a predetermined criterion. In some embodiments, the candidate phrase may be identified as the organization phrase when the evaluation score is less than a threshold. For example, the threshold may be predetermined as “1”.

In step S208, the segmentation device may segment the text based on the organization phrase. For example, the segmentation may include the organization phrase as a segment.

Yet another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed segmentation system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A computer-implemented method for segmenting a text, comprising:
identifying, by a processor, a candidate phrase shared by a plurality of sample texts;
determining, by the processor, an evaluation score for the candidate phrase;
identifying, by the processor, the candidate phrase as an organization phrase when the evaluation score meets a predetermined criterion; and
segmenting the text based on the organization phrase.

2. The method of claim 1, wherein the candidate phrase is at the end of each of the plurality of sample texts.

3. The method of claim 1, further comprising:
identifying a reference phrase associated with the candidate phrase for each of the plurality of sample texts; and
determining a first number of sample texts that contain the reference phrase.

4. The method of claim 3, further comprising:
segmenting each of the plurality of sample texts into segments;
determining a second number of the plurality of sample texts that contain a segment corresponding to the reference phrase; and
determining a segmentation failure rate based on the first number and the second number for each of the reference phrase.

5. The method of claim 4, further comprising:
determining the evaluation score by averaging the segmentation failure rates of the respective sample texts of the plurality of sample texts.

6. The method of claim 5, wherein the candidate phrase is identified as the organization phrase when the evaluation score is less than a threshold.

7. The method of claim 6, further comprising:
generating a list of the organization phrases; and
ordering the list of the organization phrases in an ascendant order of the respective evaluation scores.

8. The method of claim 1, wherein the text and the plurality of sample texts comprise address information.

9. The method of claim 1, wherein the text is segmented using a language model.

10. The method of claim 4, wherein the reference phrase is associated with an improper segmentation of the plurality of sample texts.

11. A system for segmenting a text, comprising:
a communication interface configured for receiving a plurality of sample texts;
a memory; and
a processor configured for
identifying a candidate phrase shared by the plurality of sample texts;
determining an evaluation score for the candidate phrase;
identifying the candidate phrase as an organization phrase when the evaluation score meets a predetermined criterion; and
segmenting the text based on the organization phrase.

12. The system of claim 11, wherein the candidate phrase is at the end of each of the plurality of sample texts.

13. The system of claim 11, wherein the processor is further configured for:
identifying a reference phrase associated with the candidate phrase for each of the plurality of sample texts; and
determining a first number of the plurality of sample texts that contain the reference phrase.

14. The system of claim 13, wherein the processor is further configured for:
segmenting each of the plurality of sample texts into segments;
determining a second number of the plurality of sample texts that contain a segment corresponding to the reference phrase; and
determining a segmentation failure rate based on the first number and the second number for each of the reference phrase.

15. The system of claim 14, wherein the processor is further configured for:
determining the evaluation score by averaging the segmentation failure rates of the respective sample texts of the plurality of sample texts.

16. The system of claim 15, wherein the candidate phrase is identified as the organization phrase when the evaluation score is less than a threshold.

17. The system of claim 16, wherein the processor is further configured for:
generating a list of the organization phrases; and
ordering the list of the organization phrases in an ascendant order of the respective evaluation scores.

18. The system of claim 11, wherein the text and the plurality of sample texts comprise address information.

19. The system of claim 14, wherein the reference phrase is associated with an improper segmentation of the plurality of sample texts.

20. A non-transitory computer-readable medium that stores a set of instructions, when executed by at least one processor of an electronic device, cause the electronic device to perform a method for generating a list of organization word entries, the method comprising:
identifying a candidate phrase shared by the plurality of sample texts;
determining an evaluation score for the candidate phrase;
identifying the candidate phrase as an organization phrase when the evaluation score meets a predetermined criterion; and
segmenting the text based on the organization phrase.
